(19) United States
(12) Patent Application Publication
(10) Pub. No.: US 2002/0143072 A1
(43) Pub. Date: Oct. 3, 2002

(54) Low turbidity microemulsions

(75) Inventor: Duncan T. Aust, Ridge, NY (US)

Correspondence Address: DARBY & DARBY P.C., 850 Third Avenue, New York, NY, 10022, US

(73) Assignee: Collaborative Technologies, Inc.

(21) Appl. No.: 09/774,988

(22) Filed: Jan. 31, 2001

(51) Int. Cl. C09K 3/00

(52) U.S. Cl. 516/98

(57) ABSTRACT

The present invention relates to low turbidity microemulsions which contain reduced amounts of surfactants, i.e., emulsifying agents. Methods of making such microemulsions are also disclosed. The invention also provides for pharmaceutical or cosmetic formulations based on the microemulsions described herein, containing one or more pharmacological or cosmetic agents, and methods of using such formulations.

### BACKGROUND OF THE INVENTION

1. Field of the Invention

The present invention relates to novel microemulsion compositions and formulations, and methods for producing novel microemulsions.

2. Description of Related Art

Most topical preparations currently sold contain a wide variety of pharmacologically and/or cosmetically active substances, or “active agents”. The performance of these active agents is to a large degree dependent upon the vehicle used to deliver them. These vehicles are typically chosen depending on the nature of the active agent(s). For instance, a water-soluble agent is advantageously delivered in a water-based solution. However, in the case of lipophilic active agents, topical preparations having a non-water based solvent do not usually have an aesthetically pleasing appearance, feel, and/or fragrance. Furthermore, non-water based solvents can cause unwanted side effects, such as irritation or damage to the epithelial surface to which they are applied.

To avoid the problems associated with non-water based solvents, stable emulsions are commonly employed to deliver physiologically active agents and aesthetic modifying agents. An emulsion is a disperse system in which both phases are liquids, generally consisting of either spherical micelles of one or more hydrophobic liquid materials in water, or spherical droplets of water in a hydrophobic fluid. Such emulsions are typically formed by separately preparing an oil phase containing hydrophobic ingredients and a water phase in which hydrophilic ingredients are dissolved. The two phases are then mixed together, usually while adding an emulsifying agent, or “surfactant”, to the mixture in order to reduce the surface tension between the oil and water phases, thereby making the combination of the two phases more stable. Emulsions prepared by this method usually have a smooth or pleasant feeling upon application to the skin or other epithelial surface.

Emulsions can be divided into macroemulsions and microemulsions, based on the average micelle/droplet diameter in the emulsion. The micelle size in macroemulsions range from about 2000 to 100,000 Å (corresponding to 500 to 10,000 nm), whereas the micelle sizes in microemulsions roughly ranges from 10 to 500 nm. Macroemulsions usually have a white and creamy look. This results from light being refracted when crossing a surface separating one substance from another, in this case the oil/water interface. Light is in such an emulsion refracted in a multitude of directions and colors, and therefore appears white, since white is a mixture of all colors. However, refraction only occurs when the micelle size is at least the size of the wavelength of the light passing through. Light in the visible range has wavelengths in the range 400-800 nm. Microemulsions, therefore, can appear clear or transparent, since the micelles/droplets therein are too small to deflect the incoming light. In many instances, this is cosmetically more elegant. Further reading on various microemulsion compositions can be found in, e.g., Osterloh, U.S. Pat. No. 4,946,606; Pereira et al., U.S. Pat. No. 5,216,033; Narayanan, U.S. Pat. Nos. 5,317,042 and 5,389,688; Behan et al., U.S. Pat. No. 5,347,614; Rentsch, U.S. Pat. No. 5,387,417; Wivell, U.S. Pat. No. 5,525,344;Hill, U.S. Pat. Nos. 5,623,017 and 5,707,613; and Kanga et al., U.S. Pat. No. 5,798,111; all of which are incorporated herein by reference.

A significant drawback of emulsions is their use of surfactants. Surfactants can strip the lipid barrier of the skin and the lipid bilayer of epithelial cell membranes leaving tissue vulnerable and irritating the skin. The damaged barrier permits the passage of other materials that can cause irritation or increase skin sensitivity and allergic reactions. The literature is replete with clinical evidence of the damaging consequences that can occur with the use or overuse of surfactants. For example, a publication by Effendy and Maibach (Contact Dermatitis 1995; 33:217-25) indicates that “[m]any surfactants elicit irritant reactions when applied to the skin, partially due to their relative ability to solubilize lipid membranes.” In Barany et al. (Contact Dermatitis 1999;40:98-103), the authors state that “[t]he majority of adverse skin reactions to personal care products are presumed to be caused by irritant substances, like surfactants.”

For estimating the required amount of surfactant to form a macroemulsion, a reasonable rule of thumb is an amount of surfactant corresponding to about 10-15% by weight of the amount of oil phase in the emulsion. For example, a 20% oil-in-water emulsion would translate into about 2-3% by weight surfactant in the final product. However, the production of small enough micelles for a microemulsion generally requires much higher amounts of surfactant, about 20-30% by weight. Emulsions with such high surfactant concentrations are most likely to cause or contribute to adverse skin reactions.

An especially important feature of a product intended for topical application is the appearance and texture of the product. Transparent preparations are often perceived as more elegant and aesthetically/cosmetically more pleasing. However, methods previously used to render emulsions more transparent have generally involved glycerin and/or glucose solution preparations which give the final product a “sticky” texture.

Hence, there is a need in the art for clear microemulsions which are elegant, have a pleasant consistency, and contain negligible, i.e., non-skin irritating, amounts of surfactant. The invention addresses this and other needs in the art.

### SUMMARY OF THE INVENTION

The present invention provides for low turbidity microemulsions for use in compositions for topical, oral, nasal, anal, ophthalmic, or vaginal application. The invention also provides for compositions for cosmetic and/or pharmaceutical use, comprising microemulsions with considerably reduced surfactant concentrations. The final concentration of surfactant in an emulsion according to the invention is preferably less than 10%, more preferably less than 5%, and even more preferably less than 1% by weight. The microemulsions of the invention are advantageously prepared via high-pressure high-shear technology.

In one embodiment, the invention provides for a composition for topical, oral, nasal, anal, ophthalmic, or vaginal application, which comprises a microemulsion having a reduced surfactant concentration. The microemulsion is advantageously produced by a high-pressure/high-shear processing technique, and includes a water-phase and an oil-phase. In a preferred embodiment, the water-phase contains a water-soluble material selected from glycol, glycerin, diglycerine, polyglycerin, saturated sugar solutions, or combinations thereof. Preferably, the final concentration of water-soluble material is up to 95% by weight of the emulsion. The oil-phase is preferably selected from oils, silicone materials, esters, or combinations thereof. A preferred concentration of the oil-phase or hydrophobic material in the emulsion is no greater than about 50% by weight.

In another embodiment, the invention provides for a composition for topical, oral, nasal, anal, ophthalmic, or vaginal application, comprising a low turbidity microemulsion wherein the refractive index of the aqueous phase has been matched to that of the oil phase. In a preferred embodiment, the water-soluble material has a refractive index higher than 1.333. In another preferred embodiment, the refractive indices are matched so that the difference between the two indices is no greater than about 1%. In yet another embodiment, the difference between the two refractive indices is no greater than about 0.1%, or, even more preferably, no greater than 0.01%.

In yet another embodiment, the invention provides for a formulation for topical, oral, nasal, anal, ophthalmic, or vaginal application, comprising a microemulsion with a reduced surfactant concentration and a pharmaceutical or cosmetic agent suitable for administration to humans and animals. Preferably, although not necessarily, the microemulsion is an oil-in-water emulsion, and the pharmaceutical or cosmetic agent a hydrophobic or lipophilic compound.

In still another embodiment, the invention provides for a method to produce a microemulsion which comprises the steps of (1) providing an oil-phase with a known or measured refractive index, (2) providing a water-phase comprising a water-soluble material with a known or measured refractive index, (3) matching the refractive indices of the oil-phase, water-phase, or both, and (4) combining and stirring the two phases together with a low amount of surfactant to produce an emulsion. The final concentration of surfactant is preferably lower than 10%, more preferably lower than 5%, and even more preferably lower than 1% by weight. Alternatively, the two phases are combined prior to RI matching. In a preferred embodiment, a hydrophobic pharmacologic or cosmetic agent is included in the oil-phase, and/or a hydrophilic pharmacologic or cosmetic agent in the water-phase, prior to emulsification.

### BRIEF DESCRIPTION OF THE DRAWINGS

FIG. 1 Schematic drawing of the principles for preparing a low turbidity microemulsion, according to the invention. The microemulsion comprises an oil phase 1 and a water phase 2.

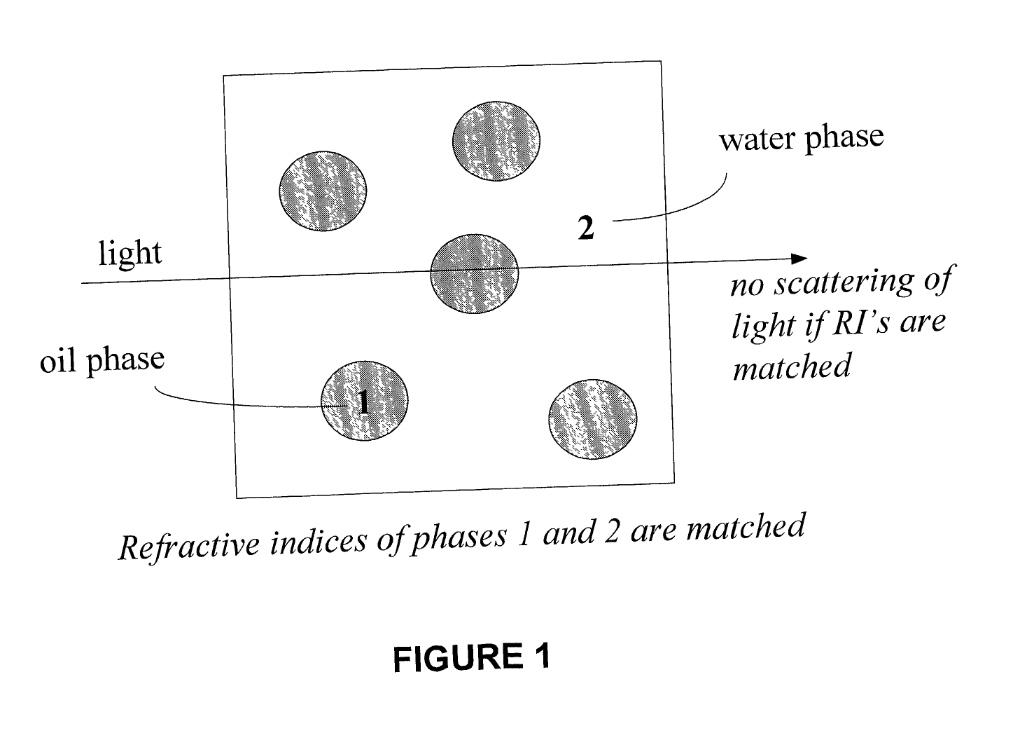

### DETAILED DESCRIPTION OF THE INVENTION

The microemulsion compositions provided herein contain significantly lower amounts of surfactant than other similar microemulsions in the art. Thereby, any composition or formulation based on the microemulsions of the invention, or treatment methods comprising such a compositions or formulations, is less likely to cause skin irritations where applied. According to the invention, the microemulsion can be formed with surfactant concentrations as low as 0.01% by weight by using a high pressure/high shear technique in combination with a water-soluble substance such as, but not limited to, diglycerine. Further, by matching the refractive index of the water-phase and the oil-phase prior to mixing the two phases, a low turbidity emulsion can be formed. The transparency of the emulsion may also be further optimized after emulsification by the addition of small amounts of water or water-soluble substances. The compositions described herein can also contain various pharmacologic and/or cosmetic agents, which further may be used in various formulations for topical, oral, nasal, anal, ophthalmic, or vaginal application, for use in humans or other animals.

Definitions

Unless otherwise stated, concentrations are provided as % by weight, or % w/w.

As used herein, the term “about” or “approximately” means within 50%, preferably 25%, more preferably 10%, and most preferably 5% of the given value. Alternatively, the term “about” means the standard deviation or variance for a given value, if available.

The terms “surfactant”, “emulsifier”, and “emulsifying agent”, used interchangeably herein, all refer to stabilizing materials used when making emulsions to decrease the interfacial tension between the two liquid phases, e.g., oil and water. Such surfactants are generally long-chain compounds containing a hydrophilic (e.g., carboxyl or sulphonate) group at one end of the molecule. The hydrophilic end of the surfactant becomes oriented towards the water at the oil/water interface.

The term “matched” refractive indices means that the difference between two refractive indices is no greater than 5%, more preferably no greater than 1%, even more preferably no greater than 0.1%, and still more preferably no greater than 0.01%.

The term “micelle” is intended to mean a substantially spherical particle with a diameter of less than about 10,000 nm, preferably in the range of about 10 to about 500 nm. A micelle may be solid or hollow, and need not be uniform in size. A micelle may contain any substance, such as, but not limited to, pharmacological and/or cosmetic agents.

The terms “pharmacological agent”, “cosmetic agent”, pharmacologically active agent”, or “cosmetically active agent” as used herein refer to any chemical material, compound, composition, or drug, suitable for administration to humans and animals which provides any desired pharmacological or cosmetic effect, including those defined in the Federal Food, Drug and Cosmetic Act. The United States Pharmacopeia (USP) and the National Formulary (NF) are the recognized standards for potency and purity for most common drug products.

The term “effective amount” of pharmacologically active agent or cosmetic agent refers to a substantially nontoxic but sufficient amount of a compound to provide the desired effect and performance at a reasonable benefit/risk ratio attending any medical or cosmetic treatment.

The terms “clear” and “translucent” are used interchangeably herein.

A “low turbidity” composition and/or emulsion as used herein refers to a composition and/or an emulsion having a clear to semi-translucent appearance.

Oil-phase

The oil-phase, or “hydrophobic phase”, can comprise any hydrophobic material(s), i.e., substances or liquids which are not, or only sparsely, soluble in or miscible with water. Preferred oil-phases comprise oils, silicone materials, and/or esters.

Preferred oils or fatty acid diglycerides include, but are not limited to, linear and branched natural vegetable oils, animal oils, and synthetic triglycerides such as the following non-limiting examples. (1) Vegetable oils: olive oil, sunflower oil, soybean oil, peanut oil, rapeseed oil, almond oil, palm oil, and the liquid components of coconut oil and palm kernel oil. (2) Animal oils: neat's foot oil and the liquid components of beef tallow. (3) Synthetic triglycerides can be of the type obtained by esterification of glycerol with C₈₋₂₂ fatty acids, for example triglycerides of caprylic acid/capric acid mixtures; triglycerides of technical oleic acid or of palmitic acid mixtures. Other useful oils include babassu oil, castor oil, cottonseed oil, chinese tallow oil, crambe oil, perilla oil, danish rapeseed oil, rice bran oil, linseed oil, safflower oil, and corn oil. Preferred saturated and unsaturated vegetable oils are those having fatty acid components with 6 to 24 carbon atoms.

Preferred silicone materials include volatile, non-volatile, and/or low viscosity silicone materials such as methylsiloxanes, polyalkylsiloxanes, polyarylsiloxanes, polyalkylarylsiloxanes, polysiloxane gums and polyethersiloxane copolymers. Linear methylsiloxanes can be selected from those having the formula:

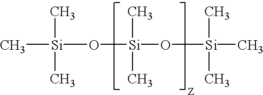

wherein z has a value from about 0 to about 3, preferably from about 0 to about 2, and most preferably from about 1 to about 2; with a viscosity of less than about 5.0 centistokes (hereinafter “cs”), preferably from about 0.5 cs to about 5.0 cs, more preferably from about 0.65 cs to about 1.0 cs, when measured at 25° C. at a pressure of one atmosphere. Linear methylsiloxanes are available from Dow Corning, and are disclosed in Dow Corning information publications from 1987 and 1990, incorporated herein by reference. Preferred examples include Dow Corning 200 Fluids, especially those having a very low viscosity, such as those having a viscosity of about 0.65 cs or 1.0 cs, and Dow Corning 245 and 345. Nonvolatile silicone fluids useful herein generally have average viscosities of at least about 1,000 cs, preferably from about 1,000 to about 2,000,000 cs, more preferably from about 10,000 to about 1,800,000 cs, even more preferably from about 100,000 to about 1,500,000 cs, at 25° C. Lower viscosity nonvolatile silicone conditioning agents with a minimum viscosity of about 50 cs, can also be used. Useful volatile cyclic silicones such as, but not limited to octamethylcyclotetrasiloxane, decamethylcyclopentasiloxane, and mixtures thereof. Examples of suitable silicone materials are also disclosed in U.S. Pat. Nos. 4,788,006; 4,341,799; 4,152,416; 3,964,500; 3,208,911; 4,364,837 and 4,465,619, all of which are incorporated herein by reference.

Preferred esters include, but are not limited to, monoesters and diesters corresponding to formulae I, II and III below. These esters are known as cosmetic and pharmaceutical oil components and as components of lubricants and greases. Among monoesters and diesters of this type, the greatest significance is attributed to the products which are liquid at room temperature (20° C.). Monoesters of formula I suitable as oil components include, for example, the methyl esters and isopropyl esters of C₁₂-C₂₂ fatty acids such as, for example, methyl laurate, methyl stearate, methyl oleate, methyl erucate, isopropyl palmitate, isopropyl myristate, isopropyl palmitate, isopropyl stearate and isopropyl oleate. Other suitable monoesters are, for example, n-butyl stearate, n-hexyl laurate, n-decyl oleate, isooctyl stearate, isononyl palmitate, isononyl isononanoate, 2-ethylhexyl palmitate, 2-ethylhexyl laurate, 2-hexyldecyl stearate, 2-octyl dodecyl palmitate, oleyl oleate, oleyl erucate, erucyl oleate and esters obtainable from technical aliphatic alcohol mixtures and technical aliphatic carboxylic acids, for example esters of saturated and unsaturated C₁₂₋₂₂ fatty alcohols and saturated and unsaturated C₁₂₋₂₂ fatty acids of the type obtainable from animal and vegetable fats. Naturally occurring monoesters or wax ester mixtures, for example of the type present in jojoba oil or in sperm oil, are also applicable.

Suitable esters from dicarboxylic acids (II) include, for example, di-n-butyl adipate, di-n-butyl sebacate, di-(2-ethylhexyl)-adipate, di-(2-hexyldecyl)-succinate and diisotridecyl azelate. Suitable diol esters (III) are, for example, ethylene glycol dioleate, ethylene glycol diisotridecanoate, propylene glycol di-(2-ethylhexanoate), butanediol diisostearate and neopentyl glycol dicaprylate.

The oil-phase may further comprise substantially hydrophobic and/or lipophilic pharmacological or cosmetic agents, such as, e.g., certain vitamins and fragrances, as well as adjuvants. (See below). Optionally, a hydrophobic agent or adjuvant may be added to the oil-phase as a dispersion. Furthermore, the oil-phase may contain a surfactant to be used in the emulsification process.

Generally, if the oil-phase comprises more than one substance, all components are mixed, by shaking, stirring, or any other means, to form a uniform or homogenous oil-phase prior to matching of refractive indices. If necessary, the oil-phase can be heated temporarily to facilitate solubilization of a selected agent. A sample may then be taken from the homogenous or uniform mixture to measure and/or modify the refractive index of the oil-phase prior to combining the oil-phase with the water-phase. Refractive index can be measured using, e.g., a refractometer.

Water-phase

The water-phase comprises water and any hydrophilic substance(s) or liquid(s) which are substantially soluble in, or miscible with, water. The water used in the preparation of the microemulsions of the invention can be, e.g., deionized, distilled, and/or sterile water.

In a preferred embodiment, the water-phase contains at least one water-soluble material with a high refractive index, preferably 1.333 or higher. Such water-soluble materials include, but are not limited to, glycol; glycerin (or glycerol); diglycerin (or diglycerol); polyglycerin (or polyglycerol); and saturated water solutions of sugars such as, e.g., glucose, sucrose, mannose, and dextrose. In addition, the water-phase may comprise substantially hydrophilic or water-soluble pharmacological or cosmetic agents, as well as adjuvants. (See below). A particularly preferred water-soluble material for the present invention is diglycerol.

Generally, all components of the water-phase are mixed, by shaking, stirring, or any other means, to form a clear or homogenous solution. If necessary, the water-phase can be heated temporarily to facilitate solubilization of the components. A sample may then be taken from the mixture to measure and/or modify the refractive index of the water-phase prior to combining the water-phase with the oil-phase.

Surfactants

A low amount of a non-ionic, anionic, or cationic surfactant or emulsifier is added to the oil- or water-phase prior to emulsification. Exemplary types of nonionic surfactants include silicone polyethers, both grafted and linear block, ethoxylated fatty alcohols, ethoxylated alcohols, ethoxylated alkyl phenols, Isolaureth-6 (polyethylene glycol ether of branched chain aliphatic C₁₂-containing alcohols having the formula C₁₂H₂₅(OCH₂ CH₂)₆OH, fatty acid alkanolamides, amine oxides, sorbitan derivatives (e.g., those commercially available from ICI Americas, Inc., Wilmington, Del., under the tradenames SPAN and TWEEN), and propylene oxide-ethylene oxide block polymers (e.g., those commercially available from BASF Corp., Parsippany, N.J. under the trademark PLURONIC). Ionic surfactants useful in preparing the emulsion include any conventional anionic surfactant such as sulfonic acids and their salt derivatives. Ionic surfactants also include any conventional cationic surfactant used in emulsion polymerization. Surfactants of these types are well known in the art and are commercially available from a number of sources. Specific examples of useful surfactant types are also disclosed in U.S. Pat. No. 5,891,954 to Gee et al., incorporated herein by reference.

The surfactant can be used in the form of a single type of surfactant (e.g., anionic, cationic or nonionic), or the surfactant can be used as a combination of two or more types provided that they are compatible with each other and the other components of the composition. Combinations of surfactant types include the combination of two or more types of anionic surfactants, the combination of two or more types of nonionic surfactants, the combination of two or more types of cationic surfactants, the combination of two or more types of surfactants selected from both the anionic and nonionic surfactants; and the combination of two or more types of surfactants selected from both the cationic and nonionic surfactants.

Matching of Refractive Indices

To produce a microemulsion according to the invention, the refractive indices of the oil-phase and the water-phase are closely matched. This can be accomplished by increasing or decreasing the refractive index of either the oil or the water-phase, for instance by adding selected components to the respective phases until there the difference between the refractive indices is less than a predetermined value. For example, the refractive index of the water phase can be increased by adding, step-wise or drop-wise, small amounts of a water-soluble material with a high refractive index, with repeated refractive index measurements until the desired refractive index has been achieved. Decreasing the refractive index typically involves diluting the water-phase by adding more water. The water-phase should be thoroughly mixed between each addition to ensure homogeneity and thus accuracy in the refractive index measurements.

Matching of the refractive indices should be conducted (1) after all components have been added the respective oil- and water-phases, including emulsifiers, pharmacological and/or cosmetic agents, and (2) before emulsification.

Generally, to produce a translucent to semi-translucent system, the refractive indices of the oil- and water-phase should be matched so that the difference between them is no greater than 5%. To produce a translucent or low-turbidity microemulsion, the differences between the water- and oil-phase should be no greater than 1%, preferably no greater than 0.1%, and even more preferably no greater than 0.01%. In another embodiment, the refractive indices are matched to up to the fourth decimal point.

The clarity or turbidity of the resulting emulsion after RI matching can be evaluated by any means known in the art, such as, e.g., visual assessment or turbidity measurements.

Emulsion

Mixing of the oil-phase and the water-phase is generally performed at a temperature of from about 15 to about 40° C., preferably at a temperature of from about 20 to about 30° C., and most preferably at ambient temperature. If a hydrophobic active agent or hydrophobic adjuvant has been added to the oil-phase as a dispersion, heating and other expensive processing steps are not required to obtain a homogenous final composition. If additional solubilization is needed, the mixture may be heated to above 40° C., preferably to about 70° C., or higher.

A small amount of surfactant is added either to the oil-phase prior to mixing the two phases, or to the oil-phase/water phase mixture. The amount of surfactant is preferably less than about 20%, more preferably less than 10%, even more preferably less than about 5%, by weight of the final emulsion. Any suitable non-ionic, anionic, or cationic surfactant known in the art, or mixtures thereof, can be used.

According to a preferred embodiment, the dispersion/emulsion is prepared by mixing under high pressure and high shear conditions about 5-50% oil-phase, about 50-95% water-phase, and about 0.01-10% surfactant, by weight of the final mixture. Optionally, the surfactant is dissolved in the oil-phase prior to mixing with the water-phase. The mixing is advantageously performed with shearing, using suitable high-pressure high-shear equipment (e.g., M110T Microfluidizer, Microfluidics Corp. Mass.), at a pressure of from about 500 psi to 50,000 psi, preferably from 5,000 to 30,000, and even more preferably from 10,000 to 20,000 psi, sufficient to pass a volume of material through the interaction chamber at least one time until homogenous and particle size confirms to the desired specification. Preferably, the emulsion formed has an average particle size ranging from about 10 to about 500 nm.

The clarity or transparency of the emulsions may be affected by, e.g., a limited diffusion of components between micelles and surrounding liquid during or after emulsification. In such cases, minor amounts of water or water-soluble compound with a high refractive index can be added to optimize the clarity or transparency of the final emulsion.

The emulsion of the invention are generally stable for a commercially relevant time of about 6 months to 2 years.

Pharmacological Agents

Suitable pharmacologically active agents include, but are not limited to, anti-acne agents, antimicrobial agents, antiinflammatory agents, analgesics, antietythemal agents, antipruritic agents, antiedemal agents, antipsoriatic agents, antifungal agents, skin protectants, sunscreen agents, vitamins, antioxidants, scavengers, antiirritants, antibacterial agents, antiviral agents, antiaging agents, protoprotection agents, hair growth enhancers, hair growth inhibitors, hair removal agents, antidandruff agents, anti-seborrheic agents, exfoliating agents, wound healing agents, anti-ectoparacitic agents, sebum modulators, immunomodulators, hormones, botanicals, moisturizers, astringents, cleansers, sensates, antibiotics, anesthetics, steroids, tissue healing substances, tissue regenerating substances, amino acids, peptides, minerals, ceramides, biohyaluronic acids, and any combination of any of the foregoing.

Preferred anti-acne agents include, but are not limited to, salicylic acid, retinoic acid, alpha hydroxy acid, benzyl peroxide, sodium sulfacetamide, clindamycin, and any combination of any of the foregoing. Preferred combinations of anti-acne agents to be incorporated in the composition include salicylic acid, retinoic acid, and hydrocortisone; sodium sulfacetamide and clindamycin; salicylic acid and clindamycin; salicylic acid, alpha hydroxy acid, and tetrahydrozoline.

Suitable antimicrobial agents include, but are not limited to, benzalkonium chloride, benzethonium chloride, chlorhexidine gluconate, chloroxylenol, cloflucarban, fluorosalan, hexachlorophene, hexylresorcinol, iodine complex, iodine tincture, para-chloromercuriphenol, phenylmercuric nitrate, thimerosal, vitromersol, zyloxin, triclocarban, triclosan, methyl-benzethonium chloride, nonyl phenoxypoly(ethyleneoxy) ethanol-iodine, para-chloro-meta-xylenol, providone-iodine complex, poloxamer-iodine complex, triclorcarban, undecoylium chloride-iodine complex, and any combination of any of the foregoing.

Suitable antiinflammatory agents include, but are not limited to, alidoxa, allantoin, aloe vera, aluminum acetate, aluminum hydroxide, bismuth subnitrate, boric acid, calamine, casein, cellulose, microporous, cholecatciferol, cocoa butter, cod liver oil, colloidal oatmeal, cystein hydrochloride, dexpanthenol, dimethicone, glycerin, kaolin, lanolin, live yeast cell derivative, mineral oil, peruvian balsam, petrolatum, protein hydrolysate, racemethionine, shark liver oil, sodium bicarbonate, sulfur, talc, tannic acid, topical starch, vitamin A, vitamin E, white petrolatum, zinc acetate, zinc carbonate, zinc oxide, hydrocortisone, betamethasone, ibuprofen, indomethicin, acetyl salicylic acid, tacrolimus, flucoinolone acetonide, sodium sulfacetamide, and any combination of any of the foregoing.

Suitable analgesics include, but are not limited to, diphenhydramine, tripeiennamine, benzocaine, dibucaine, lidocaine, tetracaine, camphor, menthol, phenol, resorcinol, matacresol, juniper tar, methylsalicylate, turpentine oil, capsicum, methyl nicotinate, b-glucan, and any combination of any of the foregoing.

Suitable antietythermal agents include, but is not limited to, tetrahydrozoline and hydracortisone.

Suitable antipruritic agents include, but are not limited to, benadryl, pramoxine, antihistamines, and any combination of any of the foregoing.

Suitable antiedemal agents, include, but are not limited to, pregnenalone acetate, tanin glyrosides, and any combination of any of the foregoing.

Suitable antipsoriatic agents include, but are not limited to, caleipotriene, coal tar, anthralin, vitamin A, and any combination of any of the foregoing. Preferred combinations of antipsoriatic agents include, but are not limited to, hydrocortisone, retinoic acid, and alpha hydroxy acid; dovonex, salicylic acid, and a sunscreen agent; indomethicin, salicylic acid, and urea; anthralin and salicylic acid; and anthralin and indomethicin. Other suitable antipsoriatic agents include, but are not limited to, caleipotriene, coal tar, anthralin, vitamin A, and any combination of any of the foregoing.

Suitable antifungal agents include, but are not limited to, clioquinol, haloprogin, miconazole nitrate, clotrimazole, metronidazole, toinaftate, undecylenic acid, iodoquinol, and any combination of any of the foregoing.

Suitable skin protectants include, but are not limited to, cocoa butter, dimethicone, petrolatum, white petrolatum, glycerin, shark liver oil, allantoin, and any combination of any of the foregoing.

Suitable sunscreen agents include, but are not limited to, ethylhexyl methoxycinnamate, avobenzone, benzophenone-3, octacrylene, titanium dioxide, zinc oxide, and any combination of any of the foregoing.

Suitable antioxidants include, but are not limited to, scavengers for lipid free radicals and peroxyl radicals, quenching agents, and any combination of any of the foregoing. Suitable antioxidants include, but are not limited to, tocopherol, BHT, beta carotene, vitamin A, ascorbic acid, ubiquinol, ferulic acid, azelaic acid, thymol, catechin, sinapic acid, EDTA, lactoferrin, rosmariquinone, hydroxytyrosole, sesamol, 2-thioxanthine, nausin, malvin, carvacone, chalcones, glutathione isopropyl ester, xanthine, melanin, guanisone, lophorphyrins, 8-hydroxyxanthine, 2-thioxanthione, vitamin B12, plant alkaloids, catalase, quercetin, tyrosine, SOD, cysteine, methionine, genistein, NDG, procyanidin, hamamelitannin, ubiquinone, trolox, licorice extract, propyl gallate, sinapic acid, and any combination of any of the foregoing.

Suitable vitamins include, but are not limited to, vitamin E, vitamin A palmitate, vitamin D, vitamin F, vitamin B6, vitamin B3, vitamin B12, vitamin C, ascorbyl palmitate, vitamin E acetate, biotin, niacin, DL-panthenol, and any combination of any of the foregoing.

A preferred sunscreen agent is a mixture of ethylhexyl methoxycinnamate, butyl methoxydibenzoylmethane, cyclomethicone, phospholipids, and water, and is available as Solarease™ from Collaborative Laboratories, Inc. of East Setauket, N.Y.

Suitable amino acids include, but are not limited to, glycine, serine, and any combination of any of the foregoing.

Cosmetic Agents

The composition preferably includes at least one cosmetic agent. A cosmetic agent is any material which imparts desirable tactile, olfactory, taste or visual properties to the surface to which the composition is applied. The cosmetic agent may be hydrophobic or hydrophilic.

An example of a cosmetic agent is a mono-, di-, tri- or polyalkylester or ether of a di-, tri-, or polyhydroxy compound, such as ethylene glycol, propylene glycol, glycerin, sorbitol or other polyol compound. Examples of such esters and ethers include, but are not limited to, saturated and unsaturated, linear and branched vegetable oils, such as soybean oil, babassu oil, castor oil, cottonseed oil, chinese tallow oil, crambe oil, perilla oil, danish rapeseed oil, rice bran oil, palm oil, palm kernel oil, olive oil, linseed oil, coconut oil, sunflower oil, safflower oil, peanut oil and corn oil. Preferred saturated and unsaturated vegetable oils are those having fatty acid components with 6 to 24 carbon atoms. A more preferred vegetable oil is soybean oil.

An example of a hydrophobic aesthetic modifying agent is a compound having the formula CₙH(2n+2−m) where n is an integer greater than or equal to 6 and m is 0 or an even integer no greater than n. Such compounds include, but are not limited to, saturated and unsaturated, linear, branched, and cyclic hydrocarbon chains. Preferred examples of such compounds include, but are not limited, mineral oil, petrolatum, permethyl fluids, polybutylenes, and polyisobutylenes.

Another example of a hydrophobic aesthetic modifying agent has the formula

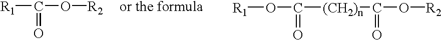

where R₁ is a saturated or unsaturated, linear, branched or cyclic C₁-C₂₄ alkyl; R₂ is hydrogen or a saturated or unsaturated, liner, branched or cyclic C₁-C₂₄ alkyl; and n is an integer from 0 to 20. Examples of such aesthetic modifying agents include, but are not limited to, isopropyl palmitate and diisopropyl adipate.

Yet another aesthetic modifying agent is silicone. Silicone may provide lubrication and/or shine to the composition. Preferably, the silicone is insoluble in water. Suitable water-insoluble silicone materials include, but are not limited to, polyalkylsiloxanes, polyarylsiloxanes, polyalkylarylsiloxanes, polysiloxane gums and polyethersiloxane copolymers. Examples of suitable silicone materials are disclosed in U.S. Pat. Nos. 4,788,006; 4,341,799; 4,152,416; 3,964,500; 3,208,911, 4,364,837 and 4,465,619, all of which are incorporated herein by reference.

Another suitable hydrophobic material which can be suspended in the composition has the formula

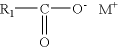

where R₁ is a saturated or unsaturated, linear, branched or cyclic alkyl having 2 to 24 carbon atoms; M(+) is N+R2R3R4R5; R2, R3 and R4 are hydrogen or a saturated or unsaturated, linear or branched alkyl or hydroxyalkyl having from 1 to 10 carbon atoms; and R5 is a saturated or unsaturated, linear, branched or cyclic alkyl or substituted alkyl having 2 to 24 carbon atoms. An example of such a material is lauramine oleate.

Adjuvants

Suitable adjuvants for the composition include but are not limited to pH adjusters, emollients, conditioning agents, chelating agents, gelling agents, viscosifiers, colorants, fragrances, odor masking agents, UV stabilizer, preservatives, bacteriostatic or bactericidal agents, and any combination of any of the foregoing. Preferred pH adjusters include, but are not limited to, aminomethyl propanol, aminomethylpropane diol, triethanolamine, citric acid, sodium hydroxide, acetic acid, potassium hydroxide, lactic acid, and any combination of any of the foregoing. One preferred bacteriostat/bactericidal agent is Germazide® (Collaborative Laboratories, Inc.).

Suitable conditioning agents include, but are not limited to, cyclomethicone, petrolatum, dimethicone, dimethiconol, silicone, quaternary amines and any combination of any of the foregoing.

The composition preferably contains less than about 0.5% by weight of preservatives, based upon 100% weight of total composition. More preferably, the composition contains from about 0.25 to about 0.5% by weight of preservatives, based upon 100% weight of total composition.

Other pharmacological agents, cosmetic agents, and adjuvants, such as those described in Remington's Pharmaceutical Sciences, 19^{th} Edition, A. R. Gennaro (1995) and the International Cosmetic Ingredient Dictionary and Handbook, 7^{th} Edition (1997), published by The Cosmetic, Toiletry, and Fragrance Association (both of which are hereby incorporated by reference), may be incorporated into the composition. Generally, all hydrophobic ingredients to be included in the final composition are added as dispersions (i.e. a dispersion of the hydrophobic ingredient is prepared before it is mixed with the base composition and the dispersion).

The following examples are intended to describe the present invention without limitation.

### EXAMPLE 1

This example illustrates the making of microemulsions containing fragrance oils, using different diglycerol concentrations. The oil-phase, having the relative composition listed in Table 1A, was mixed to uniformity. The surfactant used was Chremophor, and Germazide was added to prevent bacterial growth in the system (see below). The refractive index of the oil-phase was thereafter measured to be 1.4161 using an ABBE CT10 Refractometer (China). (See Table 1B). Six different water-phase compositions were mixed according to entries No. 1-6 in Table 1A, and their respective refractive indices measured. (See Table 1B). Each respective water-phase was mixed with oil-phase, and each mixture subjected to high-pressure/high-shear using a Silverson mixer while slowly adding remaining components. (See Table 1A). Thereafter, the sample mixture was passed 6 times through the M110 Microfluidizer (Microfluidics Corp., Mass.) with cooling so that the temperature did not exceed ambient or room temperature. The average micelle sizes in the slightly opaque (“yellowish”) to translucent emulsions were measured using a Malvern Instruments Zetasizer 3000. (See Table 1B).

TABLE 1A
Compositions for making microemulsions

| | | Amount (% w/w) | | | | | |
|---|---|---|---|---|---|---|---|
| Phase | Compound | No. 1 | No. 2 | No. 3 | No. 4 | No. 5 | No. 6 |
| Water | Deionized water | 29.72 | 29.05 | 29.00 | 29.00 | 29.50 | 29.00 |
| | Diglycerol (Solvay | 33.33 | 34.00 | 33.55 | 33.05 | 34.00 | 34.00 |
| | Interox) | | | | | | |
| | Polyethyleneglycol | 5.00 | 5.00 | 5.00 | 5.00 | 5.00 | 5.00 |
| | (PEG)-8 | | | | | | |
| Oil | Dow Corning 345 | 25.00 | 25.00 | 25.00 | 25.00 | 25.00 | 25.00 |
| | Fragrance oil | 5.00 | 5.00 | 5.00 | 5.00 | 5.00 | 5.00 |
| (Water) | Germazide MPB | 1.20 | 1.20 | 1.20 | 1.20 | 1.20 | 1.20 |
| (Oil) | Phospholipon-80 | 0.75 | 0.75 | 1.25 | 1.25 | 0.30 | 0.30 |
| | Cremophor RH-60 | — | — | — | 0.50 | — | 0.50 |

The compounds used were obtained from the following manufacturers:

| Compound | Manufacturer |
|---|---|
| Diglycerol | Solvay Interox |
| Polyethyleneglycol (PEG 8) | Union Carbide |
| Dow Corning 345 | Dow Corning |
| Germazide MPB | Collaborative Laboratories |
| Phospholipon 80 | American Lecithin (Natterman) |
| Cremophor RH-60 | BASF |
| Butylene Glycol | Daicel, Japan. |
| Catemol S-180S | Phoenix Chemicals |

TABLE 1B
Results

| | Preparation | | | | | |
|---|---|---|---|---|---|---|
| Parameter | No. 1 | No. 2 | No. 3 | No. 4 | No. 5 | No. 6 |
| Refractive index for water-phase | 1.4155 | 1.4163 | 1.4169 | 1.4163 | 1.4166 | 1.4169 |
| Refractive index for oil-phase | 1.4161 | 1.4161 | 1.4161 | 1.4161 | 1.4161 | 1.4161 |
| Average micelle diameter (nm) | 410 | 452 | 277 | 262 | —* | —* |

*An average micelle size could not be determined due to large variations in size.

System No. 2 and 3 were the clearest microemulsions formed in this experiment, although the systems otherwise were of generally similar appearance.

### EXAMPLE 2

This example illustrates the making of microemulsions using two different concentrations of diglycerol, as described in Table 2, and including a common fragrance oil. An oil-phase containing the fragrance was prepared, and its refractive index was measured to be 1.4125. Two water-phases having different diglycerol concentrations were prepared according to list No. 1 and 2 in Table 2, and their respective refractive indices were adjusted to match that of the oil-phase. Each water-phase was then separately combined with oil-phase, and the mixtures subjected to high-pressure/high-shear using a Silverson mixer at half-maximum speed. Thereafter, the sample mixture was passed 5 times through the M110 Microfluidizer with cooling.

TABLE 2

Amount (% w/w)

| Phase | Compound | No. 1 | No. 2 |
|---|---|---|---|
| Water | Deionized water | 38.10 | 31.6 |
| | Diglycerol | 30.0 | 36.4 |
| Oil | Dow Corning 345 | 25.0 | 25.0 |
| | Fragrance oil | 5.0 | 5.0 |
| (Oil) | Phospholipon-80 | 0.4 | 0.4 |
| (Water) | Germazide MPB | 1.5 | 1.5 |

### EXAMPLE 3

This example illustrates the making of microemulsions using two different concentrations of diglycerol. The refractive index of the oil-phase, prepared from components listed in Table 3, was measured to be 1.3972. To prepare the water-phase, deionized H₂O and germazide were mixed until the solution was clear. Thereafter, glycerol was added dropwise, and the mixture stirred until uniform. The refractive index of the water-phase was 1.3972 for mixture No. 1, and 1.3984 for mixture No. 2. Each water-phase was then combined with each oil-phase, and the mixtures subjected to high-pressure/high-shear using a Silverson mixer at half-maximum speed. Thereafter, the sample mixture was passed 5 times through the M110 Microfluidizer with cooling. The final product from microemulsion No. 2 was clearer than that from No. 1, although the refractive index of water-phase No. 1 was more precisely matched to that of the oil-phase than in the case of water-phase No. 2. Probably, this was due to some water entering the system in processing and thereby bringing sample No. 2 closer to the refractive index of the oil-phase, and sample 1 lower than the refractive index of the oil-phase. Accordingly, in some cases it may be desirable to experimentally optimize the clarity of the microemulsion somewhat, by introducing a slight difference between the refractive indices of the oil- and water-phases.

TABLE 3

Amount (% w/w)

| Phase | Compound | No.1 | No. 2 |
|---|---|---|---|
| Water | Deionized H₂O | 40.10 | 39.10 |
| | Diglycerol | 28.0 | 29.0 |
| | Germazide | 1.5 | 1.5 |
| Oil | Dow Corning 345 Fluid | 30.0 | 30.0 |
| | Phospholipon 80 | 0.4 | 0.4 |

### EXAMPLE 4

This example illustrates the making of clear microemulsions containing CATEZOME™ liposomes (see U.S. Pat. Nos. 6,071,535 and 5,874,105). Two water-phases and two oil-phases, Nos. 1 and 2, respectively, were prepared from components as listed in Table 4. The water- and oil-phases were mixed, first separately, then together, and subjected to high-pressure/high-shear processing until uniform. The sample mixture was passed 5 times through the M 110 Microfluidizer with cooling, then warmed and passed an additional 3 times through the microfluidizer with cooling.

TABLE 4

Amount (% w/w)

| Phase | Compound | No. 1 | No. 2 |
|---|---|---|---|
| Water | Deionized H₂O | 67.0 | 55.1 |
| | Germazide | 1.5 | 1.5 |
| Oil | Dow Corning 545 Fluid | 30.0 | 30.0 |
| | Catemole S-180-S | 1.5 | 1.40 |
| | Polyethylene glycol (PEG) 8 | — | 7.0 |
| | Butylene glycol | — | 5.0 |

### EXAMPLE 5

This example illustrates the making of microemulsions containing a fragrance. A water-phase and an oil-phase were prepared, having the compositions listed in Table 5. The refractive indices of the phases were measured, and adjusted to match that of the oil-phase to within 1% by adding diglycerol dropwise. The two phases were combined and subjected to high pressure/high shear mixing using a Silverson mixer at half-maximum speed. The sample mixture was then passed 5 times through the M110 Microfluidizer with cooling.

TABLE 5

| Phase | Compound | Amount (% w/w) |
|---|---|---|
| Water | Deionized H₂O | 31.6 |
| | Diglycerol | 36.5 |
| | Germazide | 1.50 |
| Oil | Dow Coming 545 Fluid | 25.00 |
| | Phospholipon 80 | 0.40 |
| | Fragrance (Tropical Springs) | 5.00 |

### EXAMPLE 6

This example illustrates the making of microspheres containing a fragrance. A water-phase and an oil-phase were prepared having the relative compositions listed in Table 6 and matched refractive indices. The respective refractive indices were 1.4146 for the water-phase, and 1.4140 for the oil-phase, the latter of which contained a lipophilic fragrance. The two phases were then combined, and subjected to high-pressure/high-shear treatment using a Silverson mixer, while slowly adding a small amount surfactant and bacteriostat. The sample mixture was passed 5 times through the M110 Microfluidizer with cooling. After M110 treatment, minor amounts of diglycerol and deionized water was added to further clarify the emulsion. (See Table 6).

TABLE 6

| Phase | Compound | Amount (% w/w) |
|---|---|---|
| Water | Deionized H₂O | 25.25 |
| | Diglycerol | 32.00 |
| Oil | Dow Corning 345 Fluid | 30.25 |
| | Fragrance (Polarome Citronella | 8.00 |
| | Java) | |
| (Oil) | Phospholipon 80 | 0.3 |
| (Water) | Germazide MPB | 1.2 |
| —* | Diglycerol | about 0.0003 |
| | Deionized H₂O | about 0.007 |

*Minor modifications to improve emulsion clarity after high-pressure/high-shear treatment.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims. It is further to be understood that all numerical values, provided for description, are approximate.

All patents, patent applications, publications, and other materials cited herein are hereby incorporated herein reference in their entireties. In case of conflicting terminology, the present disclosure controls.

We claim:

1. An oil-in-water microemulsion comprising:
(a) an aqueous phase comprising a water-soluble material;
(b) an oil-phase dispersed within the aqueous phase; and
(c) a surfactant;
wherein the refractive index of the hydrophobic material and the aqueous phase are matched.

2. The microemulsion of claim 1, wherein the microemulsion has been prepared by high-pressure high-shear processing.

3. The microemulsion of claim 1, wherein the water-soluble material is selected from the group consisting of glycol, glycerin, diglycerin, polyglycerin, and a saturated aqueous solution of sugar, and combinations thereof.

4. The microemulsion of claim 1, wherein the concentration of the water-soluble material is no greater than about 95% by weight of the microemulsion.

5. The microemulsion of claim 1, wherein the oil-phase comprises a compound selected from the group consisting of oil, silicone, esters, and combinations thereof.

6. The microemulsion of claim 1, wherein the oil-phase comprises no greater than about 50% by weight of the microemulsion.

7. The microemulsion of claim 1, wherein the surfactant is selected from the group consisting of non-ionic surfactants, anionic surfactants, cationic surfactants, and combinations thereof.

8. The microemulsion of claim 7, wherein the surfactant comprises no greater than about 10% by weight of the microemulsion.

9. The microemulsion of claim 1, wherein the refractive indices are matched so that the difference is no greater than 1%.

10. A formulation comprising the microemulsion of claim 1 and an effective amount of a pharmacologic agent, a cosmetic agent, or a combination thereof.

11. A method for preparing an oil-in-water microemulsion, comprising the steps of:
a) supplying a composition comprising
i) a water-phase comprising a water-soluble material;
ii) an oil-phase; and
iii) a surfactant,
wherein the refractive indices of that water-phase and the oil-phase are matched; and
b) subjecting the composition to mechanical homogenization using high pressure/high shear processing.

12. The method of claim 11, wherein the water-soluble material is selected from the group consisting of glycol, glycerin, diglycerin, polyglycerin, and a saturated aqueous solution of sugar, or combinations thereof.

13. The method of claim 11, wherein the concentration of the water-soluble material is no greater than about 95% by weight of the microemulsion.

14. The method of claim 11, wherein the oil-phase comprises a compound selected from the group consisting of oil, silicone, esters, or combinations thereof.

15. The method of claim 11, wherein the oil-phase comprises no greater than about 50% by weight of the microemulsion.

16. The method of claim 11, wherein the surfactant is selected from non-ionic surfactants, anionic surfactants, cationic surfactants, and combinations thereof.

17. The method of claim 11, wherein the surfactant comprises no greater than about 10% by weight of the microemulsion.

18. The method of claim 11, wherein the refractive indices are matched so that the difference is no greater than 1%.
